(19) United States
(12) Patent Application Publication
(10) Pub. No.: US 2017/0031259 A1
(43) Pub. Date: Feb. 2, 2017

(54) METHOD AND DEVICE FOR IMPROVING THE TONER TRANSFER IN AN ELECTROGRAPHIC DIGITAL PRINTER

(71) Applicant: Oce Printing Systems GmbH & Co. KG, Poing (DE)

(72) Inventor: Albrecht Gerstner, Oberbergkirchen (DE)

(73) Assignee: Oce Printing Systems GmbH & Co. KG, Poing (DE)

(21) Appl. No.: 15/222,013

(22) Filed: Jul. 28, 2016

(30) Foreign Application Priority Data
Jul. 28, 2015 (DE) 102015112276.6

(51) Int. Cl. G03G 15/16

(52) U.S. Cl. CPC G03G 15/0266

(57) ABSTRACT

In a method to improve the transfer of charged toner particles onto a recording medium in an electrographic printing process, the recording medium can be heated before the transfer of the charged toner particles to reduce an electrical resistance of the recording medium. A voltage can be applied between a transfer electrode and a counter-electrode to generate an electrical field at a transfer point between the transfer electrode and the counter-electrode, wherein the transfer electrode includes the charged toner particles. The recording medium can be guided to the transfer point to transition the charged toner particles from the transfer electrode to the recording medium at the transfer point under an effect of the electrical field; A current can be detected that flows between the transfer electrode and the counter-electrode across the recording medium. The voltage can be adapted based on the current.

### CROSS REFERENCE TO RELATED APPLICATIONS

This patent application claims priority to German Patent Application No. 102015112276.6, filed Jul. 28, 2015, which is incorporated herein by reference in its entirety.

### BACKGROUND

The disclosure is directed to a digital printer for printing to a recording medium with toner particles under the effect of an electrical field.

In electrographic digital printers, a latent charge image of an image substrate is inked with toner (for example liquid toner or dry toner). The toner image that is created in such a manner may be transferred onto a recording medium directly from the image substrate or indirectly via a transfer station. In this transfer step, an electrical field is used in order to print the toner image onto the recording medium.

The quality of the transfer of toner onto the recording medium typically depends on the voltage that must be applied in the transfer station to generate the electrical field. For example, a voltage for the toner transfer is applied between a transfer roller and a counter-pressure roller of the transfer station. The recording medium may comprise paper or cardboard with a relatively high thickness of up to 500 μm. Such a recording medium typically has a relatively high electrical resistance, which leads to the situation that relatively high voltages must be applied in the transfer station to provide an electrical field with a specific field strength. High voltages may lead to damage to the toner and/or to a degradation of the toner transfer.

United States Patent Application Publication No. 2004/0175208A1 describes a printer with a transfer roller that can be heated. Great Britain Patent No. 1408290A and U.S. Pat. No. 6,049,680 describe printers with a roller for heating a recording medium. United States Patent Application Publication No. 2010/0296139A1 describes a printer in which a specific setting parameter is regulated in order to regulate a color value of a print image to a desired value. United States Patent Application Publication No. 2015/0037054A1 describes a printer that may be adapted to current environmental conditions.

In U.S. Pat. No. 6,805,929B2, paper-based recording media are described that have an electrical resistance that lies within a specific resistance range which is particularly well suited for an electrographic printing system. However, the limitation to a specific type of recording medium with specific electrical properties is not practical (in particular in printing of packaging) and leads to increased paper costs.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example digital printer.

FIG. 2 illustrates an example print group of the digital printer of FIG. 1.

FIG. 3a illustrates controller according to an exemplary embodiment of the present disclosure.

FIG. 3b illustrates a division of the voltage between transfer roller and counter-pressure roller according to an exemplary embodiment of the present disclosure.

FIG. 4a illustrates a control loop for the adjustment of the electrical field for an electrographic printing process according to an exemplary embodiment of the present disclosure.

FIG. 4b illustrates a model of the electrical properties of the electrographic printing process according to an exemplary embodiment of the present disclosure.

FIG. 4c illustrates correlations between the current and/or the voltage in an electrographic printing process according to exemplary embodiments of the present disclosure.

FIG. 4d illustrates a curve of the electrical resistance of a recording medium as a function of the temperature according to an exemplary embodiment of the present disclosure.

FIG. 5 illustrates a flowchart of a method for the improvement of the transfer of toner in an electrographic printing process according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present document deals with the technical object to cost-effectively increase the quality of the toner transfer. A high print quality should thereby be achieved even given use of different types of paper/paperboard-based recording media having relatively high thickness.

According to one aspect, a method is described for the improvement of the transfer of toner onto a recording medium in a printing process in which the transfer of toner takes place under the effect of an electrical field. The method includes the heating of the recording medium before transfer of the toner. Furthermore, the method includes the transfer of the toner under the effect of an electrical field on the heated recording medium.

According to an additional aspect, a print group for a digital printer is described. The print group comprises a heater that is configured to heat a recording medium. Furthermore, the print group comprises a transfer electrode and a counter-electrode between which a voltage may be applied in order to produce an electrical field at a transfer point between the transfer electrode and counter-electrode, such that toner is transferred onto the heated recording medium at the transfer point under the effect of the electrical field. To generate the voltage between the transfer electrode and the counter-electrode, the transfer electrode and the counter-electrode are set to different potentials.

By heating the recording medium for the toner transfer, the electrical resistance of the recording medium may be reduced so that the electrical field required for the toner transfer may be generated with a reduced voltage (i.e. with a reduced potential difference). This leads to an increase of the quality of the toner transfer, in particular given paper/paperboard-based recording medium having relatively high thickness.

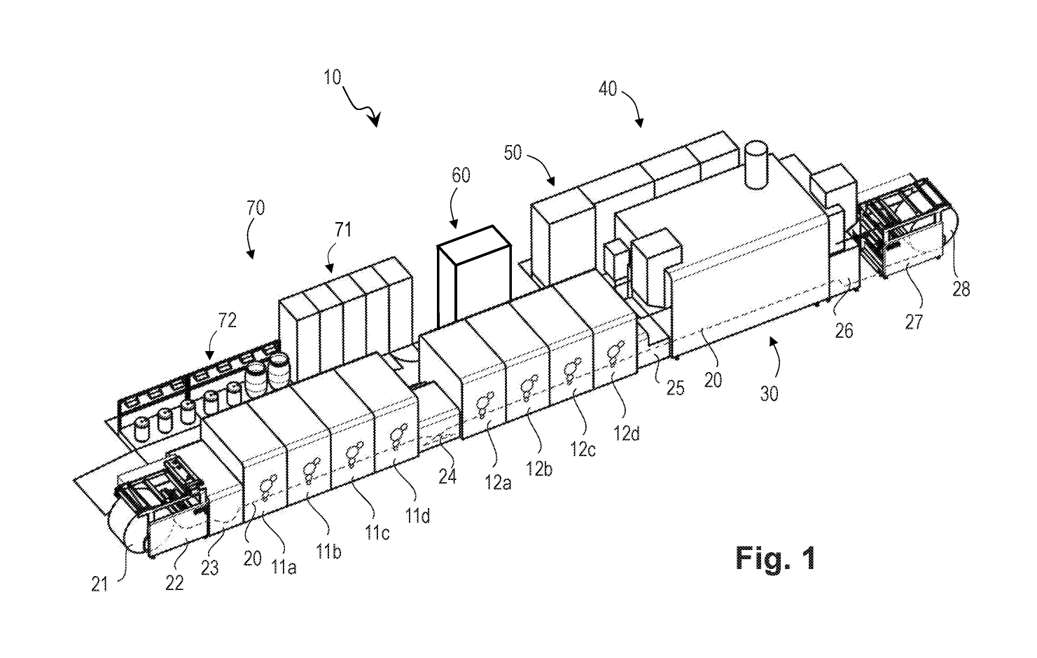

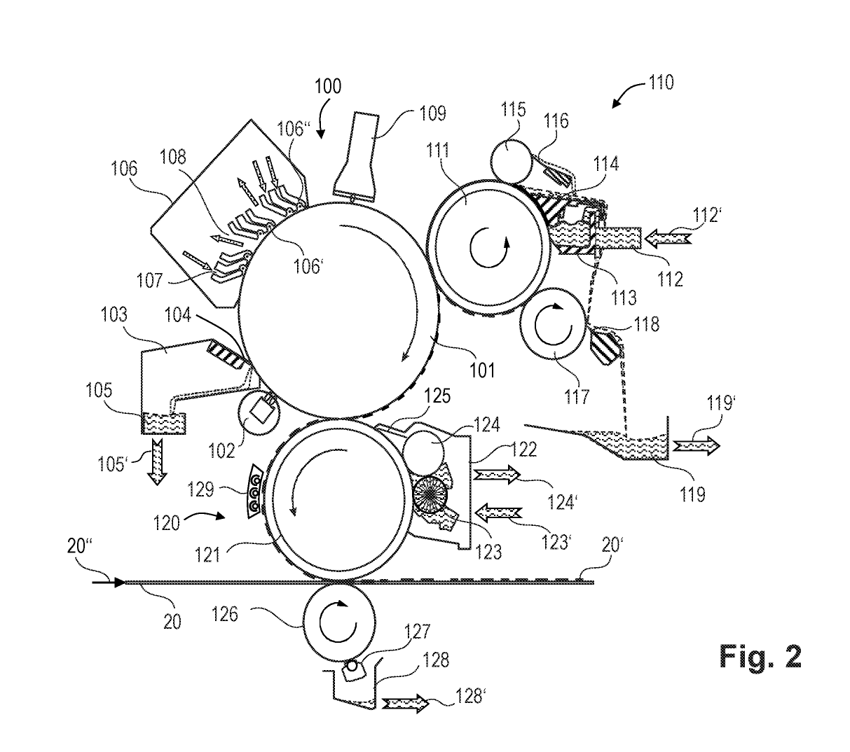

FIG. 1 illustrates an example digital printer 10. The digital printer 10 can be configured to print to a recording medium 20 has one or more print groups 11a-11d and 12a-12d that print a toner image (print image 20′; see FIG. 2) onto the recording medium 20. As shown, a web-shaped recording medium 20 (as a recording medium 20) is unrolled from a roll 21 with the aid of a take-off 22 and is supplied to the first print group 11a. The print image 20′ is fixed on the recording medium 20 in a fixer 30. The recording medium 20 may subsequently be taken up on a roll 28 with the aid of a take-up 27. Such a configuration is also designated as a roll-to-roll printer.

Further examples of the digital printer 10 are described in U.S. Patent Application Publication No. 2014/0212632 (of U.S. application Ser. No. 14/166,312), and corresponding German Patent Application No 10 2013 201 549 and Japanese Patent Application No. 2014/149526A. Each of these applications is incorporated herein by reference in their entirety.

FIG. 2 illustrates example print groups 11, 12. The print group depicted in FIG. 2 are configured to utilize the electrophotographic principle, given which a photoelectric image substrate (in particular a photoconductor 101) is inked with charged toner particles with the aid of a liquid developer, and the toner image that is created in such a manner is transferred to the recording medium 20. The print group 11, 12 is essentially comprised of an electrophotography station 100, a developer station 110 and a transfer station 120.

The electrophotography station 100 includes a photoelectric image substrate that has a photoelectric layer (what is known as a photoconductor) on its surface. The photoconductor can be configured as a roller (photoconductor roller 101) and has a hard surface. In operation, the photoconductor roller 101 rotates past the various elements to generate a print image 20′ (rotation in the direction indicated by the arrow).

The electrophotography station 100 includes a character generator 109 that generates a latent image on the photoconductor 101. The latent image is inked with toner particles by the developer station 110 in order to generate an inked image (i.e. a toner image). For this, the developer station 110 has a rotating developer roller 111 that brings a layer of liquid developer onto the photoconductor 101.

The inked image rotates with the photoconductor roller 101 up to a first transfer point, at which the inked image is essentially completely transferred onto a transfer roller 121. The recording medium 20 travels in the transport direction 20″ between the transfer roller 121 and a counter-pressure roller 126. The contact region (nip) represents a second transfer point in which the toner image is transferred onto the recording medium 20. Additional details with regard to the print groups 11, 12 are described in U.S. Patent Application Publication No. 2014/0212632, as well as in corresponding German Patent Application No 10 2013 201 549 and Japanese Patent Application No. 2014/149526A.

Exemplary embodiments of the present disclosure are directed to increasing the quality of the transfer of toner onto the recording medium 20, in particular for recording media 20 which comprise paper, paperboard or cardboard. The toner transfer is in particular dependent on the field strength of the electrical field at the transfer point, i.e. at the roller nip between the transfer roller 121 and the counter-pressure roller 126.

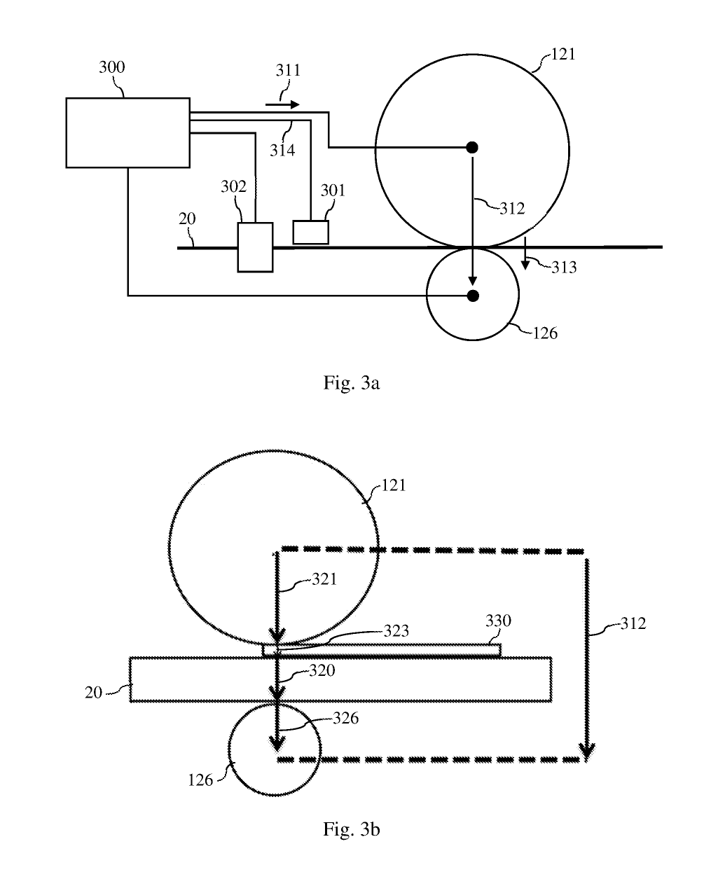

FIG. 3a illustrates a controller 300 according to an exemplary embodiment of the present disclosure. In an exemplary embodiment, the controller 300 is configured to adjust the field strength of the electrical field for the transfer process from a transfer roller (e.g. transfer roller 121) onto a recording medium (e.g. recording medium 20). In an exemplary embodiment, the controller 300 is configured to adjust the strength of an electrical field 313 at the roller nip between the transfer roller 121 and the counter-pressure roller 126. In this example, the controller 300 can be configured to adapt, regulate, and/or otherwise adjust the voltage 312 (i.e. the potential difference) and/or the current 311 between the cores of the transfer roller 121 and the counter-pressure roller 126. The controller 300 can be configured to continuously adapt or regulate the voltage 312 and/or the current 311.

In an exemplary embodiment, as an alternative to the use of a transfer roller 121, a direct toner transfer from the photoconductor 101 onto the recording medium 20 can be used. In this example, the voltage 312 (i.e. the potential difference) and/or the current 311 between the cores of the photoconductor 101 and the counter-pressure roller 126 may be adapted or regulated. The adapting or regulating can be continuous

The controller 300 can be an embodiment of the controller 60 or otherwise implemented in the digital printer 10, and configured to control one or more operations (e.g., adapt/regulate/adjust the voltage 312 and/or current 311) of the digital printer 10. The controller 300 can alternatively be implemented in the print group 11, 12 or externally located from the print group 11,12, and be configured to control one or more operations of the print group 11, 12.

FIG. 3b illustrates an example of a division of the voltage 312 (i.e. the potential difference) between transfer roller 121 and counter-pressure roller 126 according to an exemplary embodiment of the present disclosure. A first part of the voltage 312 (voltage drop 321) typically drops at the transfer roller 121 (for example at an elastomer layer of the transfer roller 121). An additional part of the voltage (voltage drop 323) drops at the toner layer 330 in the roller nip, and a further part (voltage drop 320) drops across the recording medium 20. Moreover, a part of the voltage 312 (voltage drop 326) may also drop across the counter-pressure roller 126. The field strength of the electrical field 313 which acts on the toner layer 330 thereby depends on the voltage drop 323 across the toner layer 330. The voltage drop 323 across the toner layer 330 may be increased in that the voltage drop 320 across the recording medium 20 is reduced, for example. The voltage drop 320 across the recording medium 20 may be reduced via a reduction of the electrical resistance (in particular the transversal resistance) of the recording medium 20.

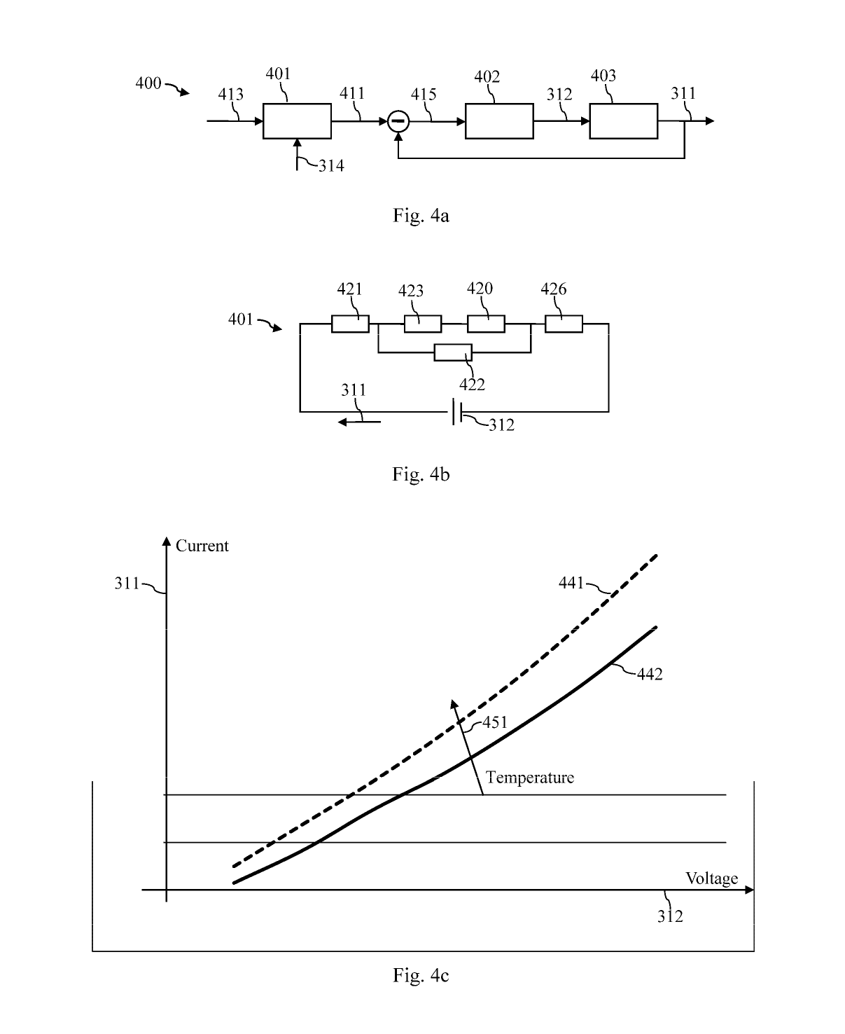

As shown by the current/voltage curves 441, 442 illustrated in FIG. 4c, the current 311 increases with an increasing temperature 451 of the recording medium 20 given invariant voltage 312. In other words, the electrical resistance of the recording medium 20 decreases with increasing temperature 451. This is also illustrated in FIG. 4d, in which the electrical resistance 452 of an example of a recording medium 20 is presented as a function of the temperature 451 of the recording medium 20. In this example, the electrical resistance is the electrical resistance transversally through the recording medium 20, from the top side of the recording medium 20 (which is printed to) to the underside of the recording medium 20. This electrical resistance is also designated as a transversal resistance or as a volume resistance. In an exemplary embodiment, the electrical resistance 452 initially decreases with increasing temperature 451. This may be associated with water escaping from fibers of the recording medium 20 with increasing temperature 451, which thus leads to an increased conductivity of the recording medium 20. On the other hand, in particular given paper-, paperboard- and/or cardboard-based recording media 20 it is to be observed that the electrical resistance 452 increases again as of a specific temperature 451. This may be associated with evaporation effects of moisture in the recording medium 20. Overall, a specific temperature range 452 in which a relatively small electrical resistance 452 may be adjusted thus results. This temperature range 453 may be determined experimentally for a specific recording medium 20.

With reference to FIG. 3a, in an exemplary embodiment, the controller 300 can be configured to control a heater 302. The heater 302 can be configured to vary the temperature 451 of the recording medium 20. For example, heater 302 can be configured to increase the temperature 451 of the recording medium 20. In particular, the temperature 451 of the recording medium 20 may be varied such that the temperature 451 lies within a temperature range 453 in which the recording medium 20 exhibits an optimally low electrical resistance 452 (for example an electrical resistance 452 that is lower than a predefined resistance threshold). The heater 302 is not limited to increasing the temperature and can include a cooling component configured to reduce the temperature of the recording medium.

The controller 300 may be configured to control or regulate the heater 302 such that a desired temperature 451 of the recording medium 20 appears. In an exemplary embodiment, a temperature sensor 301 may be provided that is configured to detect, sense, or otherwise measure the temperature 451 of the recording medium 20 and to generate temperature data 314 corresponding to the detected/sensed/measured temperature 451 of the recording medium 20. The temperature sensor 301 can be positioned between the heater 302 and the transfer point, and be configured to relay the temperature data 314 to the controller 300.

In an exemplary embodiment, the controller 300 includes processor circuitry configured to perform one or more operations of the controller 300, including controlling (e.g., adapting, regulating, adjusting) the voltage 312 and/or the current 311, and/or controlling the heater 302.

By heating the recording medium 20 (in particular of the paper or paperboard), the electrical resistance 452 of the recording medium 20 and the voltage drop at the recording medium 20 can be reduced. The electrical voltage 312 (i.e. the potential difference) may thus be reduced in order to generate a desired voltage drop at the transfer point (i.e. at the roller nip). Alternatively or additionally, the field strength of the electrical field at the transfer point may be increased given an unchanged voltage 312. Interference and non-uniformities of the print image that arise due to high voltages 312 may thus be avoided via the heating of the recording medium 20. Moreover, the spectrum of different recording media 20 which may be printed to by a digital printer 10 may be expanded. For example, via the heating of the recording medium 20, recording media 20 with an increased size or thickness may be used. Furthermore, an electrical inhomogeneity in the recording medium 20 may be reduced via the heating, which leads to an increased homogeneity of the print image transfer.

The printing capability and the homogeneity of the recording medium 20 may thus be improved via the heating of the recording medium 20 before implementation of the toner transfer. In an exemplary embodiment, the heating of the recording medium 20 can be immediately before the implementation of the toner transfer. In an exemplary embodiment, to heat the recording medium 20, the heater 302 may be configured to generate, for example, IR (infrared) radiation, hot air, contact heat, and/or use another heating process and/or technique as would be understood by one of ordinary skill in the relevant arts. For example, contact heat may be transferred to the recording medium 20 using stationary and/or rotating elements. Alternatively or additionally, a heating of the recording medium 20 may be produced via the application of a warm fluid onto the recording medium 20.

In an exemplary embodiment, the heater 302 is configured to heat the recording medium 20 such that a substantially uniform tempering takes place over the entire cross section of the recording medium 20. The heater 302 may be configured to heat not only the (upper and/or lower) surface of the recording medium 20 but also the entire inner region between the surfaces of the recording medium 20 (if applicable to a nearly identical temperature). This may be achieved via electromagnetic radiation in the medium wave and/or in the microwave range (for example in the GHz range) and/or in the infrared (IR) range. Alternatively or additionally, an optimally uniform heating may be produced via an action of heat on both surfaces (i.e. top side and bottom side) of the recording medium 20. The heater 302 may therefore be configured to apply, for example, electromagnetic radiation, hot air, contact heat, and/or another heating technique to both surfaces of the recording medium 20.

In an exemplary embodiment, the heater 302 may be arranged in one or more print groups 11, 12 of a printing system. For example, a heater 302 via which the recording medium 20 is brought to a temperature 451 that is optimal relative to the electrical resistance 452 may be arranged in every print group 11 of a printing system 10. In an exemplary embodiment, the heater 302 is included in one or more print groups 11 and/or in one or more print groups 12.

As presented above, the controller 300 may be configured to control or regulate the current 311 and/or the voltage 312 for the toner transfer in a print group 11. In an exemplary embodiment, the current 311 may be regulated based on a nominal current or the voltage 312 may be regulated based on a nominal voltage. The nominal current or the nominal voltage may thereby depend on the temperature 451 of the recording medium 20 at the transfer point. For example, the controller 300 may be configured to determine a nominal current or a nominal voltage based on the temperature data 314.

FIG. 4a illustrates a control loop 400 according to an exemplary embodiment of the present disclosure. In this example, the control loop 400 of the current 311 between the transfer roller 121 and the counter-pressure roller 126 (as a controlled variable) is shown. Using an adaptive model 401 of the controlled system 403, a nominal current 411 (as an adaptive reference variable) that is to flow between the transfer roller 121 and the counter-pressure roller 126 may be determined from, for example, a nominal field strength 413 of the electrical field 313 at the nip. The adaptive model 401 that is used for the determination of the nominal current 411 thereby depends on the current temperature data 314 of the recording medium 20. The nominal current 411 may thus be adapted to the current temperature 451 of the recording medium 20.

In an exemplary embodiment, the currently measured current 311 may be subtracted from the nominal current 411 to determine a control error 415. Using a controller 402 (for example a controller with P(roportional), I(ntegral) and/or D(ifferential) part), the voltage 312 to be set between transfer roller 121 and counter-pressure roller 126 may be determined (as a control variable). In an exemplary embodiment, the controller 402 includes processor circuitry configured to perform one or more operations of the controller 402. In an exemplary embodiment, the controller 300 includes the controller 402. The current 311 is produced through the controlled system 403 (i.e. the electrical path between transfer roller 121 and counter-pressure roller 126), which current 311 is then compared again with the nominal current 411. In this example, the nominal current 411 may have been updated (e.g., based on the temperature data 314) prior to the comparison with the current 311.

In an exemplary embodiment, the temperature 451 of the recording medium 20 may be regulated by the controller 300 to a nominal temperature, for example to a nominal temperature from the temperature range 453, via which a relatively small electrical resistance 452 of the recording medium 20 results. The fixed nominal temperature then typically corresponds (given a recording medium 20 with consistent properties) to a fixed nominal current 411 that may be regulated by the control loop 400.

FIG. 4b illustrates an adaptive model 401 according to an exemplary embodiment of the present disclosure. In an exemplary embodiment, the adaptive model 401 is an adaptive model of the controlled system 403. In an exemplary embodiment, the model 401 comprises a first electrical resistance 421, a second electrical resistance 423, a third electrical resistance 420, a fourth electrical resistance 422, and a fifth electrical resistance 426.

The first electrical resistance 421 can correspond to the electrical resistance of the transfer roller 121 (in particular of the elastomer layer of the transfer roller 121).

The second electrical resistance 423 can correspond to the electrical resistance of the filled nip (typically filled with liquid developer and possibly with toner). The second electrical resistance 423 may depend on the quantity of toner (for example on the number of toner layers) that is located in the roller nip between transfer roller 121 and recording medium 20.

The third electrical resistance 420 can correspond to the electrical resistance of the recording medium 20. The third electrical resistance 420 may depend on the temperature 451 of the recording medium 20.

The fourth electrical resistance 422 can correspond to the electrical resistance of the electrical connection between transfer roller 121 and counter-pressure roller 126 past which the recording medium 20 is directed. The fourth electrical resistance 422 may be used to model a parasitic current that flows laterally past the recording medium 20 (in particular in a region of the directly contacting transfer roller 121 and counter-pressure roller 126 in which no recording medium 20 is located). This parasitic current can depend on the voltage 312. A reduction of the voltage 312 (for example due to a reduction of the electrical resistance 420, 452 of the recording medium 20) may lead to a substantial reduction of the parasitic current.

The fifth electrical resistance 426 can correspond to the electrical resistance of the counter-pressure roller 126.

The individual resistances 421, 423, 420, 422, 426 may be determined based on properties of the print group 11 and depending on environmental conditions. In particular, characteristic lines may be stored for the individual resistances 421, 423, 420, 422, 426 (i.e. for the individual model parameters), which characteristic lines reflect a correlation between the resistances 421, 423, 420, 422, 426 and current values of framework parameters of the printing process (such as the temperature, the moisture and/or the electrical resistance of the transfer roller 121, of the recording medium 20 and/or of the counter-pressure roller 126). These characteristic lines may be determined theoretically and/or experimentally. The current values of the individual resistances 421, 423, 420, 422, 426 (i.e. the current values of the model parameters) may thus be determined by determining the current values of the framework parameters 414. In particular, the third electrical resistance 420 may be determined (and adapted, if applicable) depending on the temperature data 314. The model 401 may thus be adapted continuously to current values of the temperature 451 of the recording medium 20 and/or if applicable to current values of additional framework parameters.

The voltage drop at the second electrical resistance 423 determines the field strength of the electrical field 313 at the nip. Given knowledge of the current values of the individual resistances 421, 423, 420, 422, 426, the current 311 via which a specific voltage drop at the second electrical resistance 423 is produced may be determined using the model 401. In other words: the nominal current 411 via which an electrical field 313 with the nominal field strength 413 is produced may be determined using the model 401. This nominal current 411 may then be adjusted, and if applicable, may be adapted to modified temperature data 314, using the control loop 400. It may thus be achieved that an electrical field 313 with consistent nominal field strength 413 is present at the nip—and thus a consistently high print quality is achieved—even given a change to the temperature 451 of the recording medium 20.

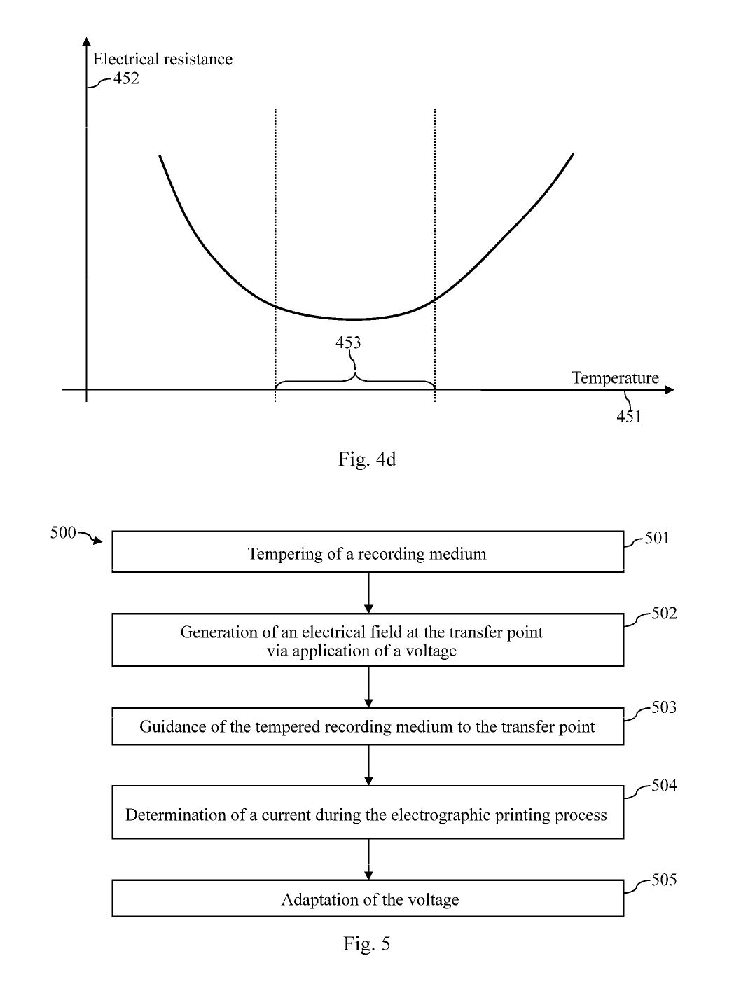

FIG. 5 illustrates a flowchart of a method 500 to improve the transfer of charged toner particles to a recording medium 20 in an electrographic printing process according to an exemplary embodiment. In an exemplary embodiment, dry toner or liquid toner may be used in the electrographic printing process. In an exemplary embodiment, the method 500 includes the tempering 501 (e.g., the heating) of the recording medium 20 before the transfer of the charged toner particles. The electrical resistance of the recording medium 20 (in particular the transversal resistance or the volume resistance of the recording medium 20) for the toner transfer may be reduced via the tempering of the recording medium 20 (in particular via the heating of the recording medium 20).

In an exemplary embodiment, the recording medium 20 may be heated immediately before the transfer of the charged toner particles, such that the time period between heating of the recording medium 20 and the transfer of the toner particles is as short as possible, for example smaller than a predefined time threshold. In an exemplary embodiment, the time threshold thereby depends on the temperature 451 of the recording medium 20 and/or on the moisture of an immediate environment of the recording medium 20. Via the prompt heating of the recording medium 20, it may be achieved that moisture present in the recording medium 20 remains in the recording medium 20 up to the transfer point being reached, and thus results in an optimally low electrical resistance 452.

Given use of a plurality of print groups 11, 12 (i.e. given implementation of a plurality of toner transfer steps), a cooling of the recording medium 20 may possibly take place after a toner transfer step in order to suppress an evaporation of moisture between successive toner transfer steps. For example, the recording medium 20 may be heated immediately before a first toner transfer step (in order to reduce the electrical resistance 452 for the first toner transfer step). Furthermore, the recording medium 20 may be cooled again immediately after the first toner transfer step (in order to suppress an evaporation of moisture from the recording medium 20). The recording medium 20 may then be heated again immediately before a second, subsequent toner transfer step. Via the cooling of the recording medium 20 in-between the first and second toner transfer steps, it may be ensured that the electrical resistance 452 of the recording medium 20 may also be effectively reduced again via heating for the second toner transfer step. A print group 11 may thus comprise a first heater 302 before the transfer electrode (for example the transfer roller 121) in the transport direction 20″ to heat the recording medium 20. Furthermore, the print group 11 may comprise a second heater (that includes a cooling component such as an air conditioner) after the transfer electrode (for example the transfer roller 121) in the transport direction 20″ (not shown in FIG. 3a) that is configured to cool the recording medium 20 again.

In an exemplary embodiment, the method 500 additionally includes the application 502 of a voltage 312 (i.e. of a potential difference) between a transfer electrode and a counter-electrode to generate an electrical field 313 at the transfer point between the transfer electrode and the counter-electrode. The surface (for example, a surface shell) of the transfer electrode thereby has the charged toner particles. In an exemplary embodiment, the transfer electrode may comprise a transfer roller 121 via which a toner image is conveyed at the transfer point (in the event of an indirect toner transfer). In the event of a direct toner transfer, the transfer electrode may comprise a photoconductor roller 101. The counter-electrode may comprise a counter-pressure roller 126 via which the recording medium 20 is pressed against the transfer roller 121 or against the photoconductor roller 101. The transfer roller 121 and the counter-pressure roller 126 may form a roller nip at the transfer point, wherein the recording medium 20 is transported between the transfer roller 121 (or the photoconductor 101) and the counter-pressure roller 126, and wherein the toner image is transferred from the transfer roller 121 onto the recording medium 20 under the effect of the electrical field 313 in the roller nip.

In an exemplary embodiment, the method 500 additionally includes the direction 503 of the recording medium 20 to or through the transfer point so that the charged toner particles pass at the transfer point from the transfer electrode onto the recording medium 20 under the effect of the electrical field 313.

In an exemplary embodiment, the voltage 312 may be reduced via the tempering 501 of the recording medium 20 (in comparison to an untempered recording medium 20) to generate an electrical field 313 with a defined nominal field strength 413. The reduction of the voltage 312 is thereby achieved via the reduction of the electrical resistance 452 of the recording medium 20. Via the reduction of the voltage 312, artifacts in the toner transfer are avoided so that the transfer of the charged toner particles may be improved overall. In particular, breakdowns through the recording medium 20 and/or relocation processes of toner particles may be avoided.

In an exemplary embodiment, the method 500 may additionally include the detection 504 of a current 311 that flows between the transfer electrode and the counter-electrode across the recording medium 20. In an exemplary embodiment, the method 500 may include the adaptation 505 of the voltage 312 based on the current 311.

As was already presented above, the electrical resistance 452 of the recording medium 20 may be reduced via the tempering of the recording medium 20 for the toner transfer. This has the consequence that the total resistance of the electrical connection path between transfer electrode and counter-electrode is reduced. In an exemplary embodiment, a variation of the ratio between current 311 and voltage 312 consequently results due to the tempering of the recording medium 20 (in comparison to an untempered recording medium 20). In an exemplary embodiment, this variation of the ratio may be taken into account in that the voltage 312 is adapted (for example in order to adjust a specific current 311).

In an exemplary embodiment, the voltage 312 may be adapted such that the current 321 is regulated based on a nominal current 411. The nominal current 411 thereby typically depends on a nominal field strength 413 of the electrical field 313 at the transfer point. In an exemplary embodiment, a constant field strength of the electrical field 313 at the transfer point may be produced via a current regulation, whereby an improvement of the toner transfer is produced in turn.

In an exemplary embodiment, the method 500 may additionally include the adaptation of a quantity of thermal energy that is transferred to the recording medium 20 upon tempering (in particular upon heating). In an exemplary embodiment, the quantity of thermal energy may be adapted such that the voltage 312 which is required for the regulation of the current 311 is reduced. In other words: a current regulation may be implemented so that the current 311 (as a controlled variable) is regulated based on the nominal current 411. In the steady state, the voltage 312 (as a control variable) that adjusts the current 311 then has a specific voltage magnitude. The quantity of thermal energy which is transferred to the recording medium 20 may then be adapted (regulated, if applicable) such that the voltage magnitude is reduced (for example minimized). It may thus be automatically achieved that the toner transfer takes place with a recording medium 20 that has a minimum possible electrical resistance 452. The quality of the toner transfer may thus be further improved.

In an exemplary embodiment, the method 500 may additionally include the determination of temperature data 314 that indicate a temperature 451 of the recording medium 20 after the heating 501. In an exemplary embodiment, the quantity of thermal energy that is transferred to the recording medium 20 upon tempering 501 may be adapted depending on the temperature data 314. In an exemplary embodiment, the quantity of thermal energy may be adapted such that the temperature 451 of the recording medium 20 is regulated based on a nominal temperature after the heating 501. In an exemplary embodiment, the electrical resistance of the recording medium 20 may be reduced (e.g., minimized) via the adjustment of a determined nominal temperature. The reduction may be based on a previously determined characteristic resistance/temperature line as shown in FIG. 4d).

In an exemplary embodiment, in a predefined temperature range 452, the recording medium 20 may exhibit an electrical resistance 452 that is less than or equal to a predefined resistance threshold. In an exemplary embodiment, the recording medium 20 may then be heated to a temperature 451 outside of the predefined temperature range 453. In particular, a temperature 451 outside of the temperature range 452 may be used as a nominal temperature for a temperature regulation.

In an exemplary embodiment, the tempering 501 of the recording medium may take place via transfer of thermal energy to the recording medium 20 by, for example, infrared radiation, via transfer of thermal energy to the recording medium 20 using hot air, and/or via transfer of thermal energy to the recording medium 20 using contact heat.

In an exemplary embodiment, the recording medium 20 may have fibers (in particular paper fibers) in which water is bound. For example, the recording medium 20 may comprise paper, cardboard and/or paperboard. Water is released from the fibers due to the supplied thermal energy, whereby the mobility of the water in the recording medium 20 is increased. In particular, the water distributes in the structure of the recording medium 20 that is filled with minerals and air. The mobility of ions in the recording medium 20 is thereby also increased, which leads to a reduction of the electrical resistance 452 of the recording medium 20.

This phenomenon of the reduction of the electrical resistance 452 is surprising since an evaporation from the recording medium 20—and therefore an increase of the electrical resistance 452—would be expected due to the increase in temperature 451. As explained in connection with FIG. 4d, however, the latter effect only appears above a specific limit temperature. Below the limit temperature, a reduction of the electrical resistance 452 of the recording medium 20 may be produced by increasing the temperature 451, contrary to expectation.

In an exemplary embodiment, the recording medium 20 may have a thickness of, for example, 250 μm or 400 μm or more (but not limited thereto), and/or a grammage of, for example, 200 g/m² (but not limited thereto). Such recording media 20 typically have very high electrical resistance at room temperature, and therefore require relatively high voltages 312 for the toner transfer. In an exemplary embodiment, by heating the recording medium 20 to temperatures 451 in a range from, for example, 30°-90°, the electrical resistance of such recording media 20 may be reduced, which in turn leads to a significant reduction of the applied voltage 312. In an exemplary embodiment, a temperature range includes a maximum temperature of, for example, 60° C. (for example, a range from 30°-60° C.) to avoid a possible fusing of the toner particles.

In an exemplary embodiment, the method 500 may additionally include the determination of a current value of an (additional) framework parameter of the printing process. In an exemplary embodiment, a change in a framework parameter produces a change to the current 311 between the transfer electrode and the counter electrode, even given a constant voltage 312. In other words: the framework parameter has an influence on the electrical properties of the path between transfer electrode and counter-electrode. Current values for a plurality of framework parameters may be analogously determined.

In an exemplary embodiment, the framework parameters may include, for example, one or more of: a thickness and/or a width of the recording medium 20 that is arranged between the transfer electrode and the counter-electrode during the printing process; a moisture of the recording medium 20; a temperature and/or a moisture in an environment of the transfer point; a temperature of the transfer roller 121 and/or of the counter-pressure roller 126; and/or a conductivity and/or an electrical resistance of the transfer roller 121 and/or of the counter-pressure roller 126; a mechanical force with which the counter-pressure roller 126 is pressed onto the transfer roller 121; and/or a length of the counter-pressure roller 126 and/or the transfer roller 121 transversal to the transport direction 20″ of the recording medium 20. In an exemplary embodiment, the current values of one or more framework parameters may be determined from a database and/or on the basis of sensor data.

In an exemplary embodiment, the method 500 may additionally include the adaptation of a control loop 400 for adjustment of the electrical field 313 (in particular of a model 401) depending on the current values of the one or more framework parameters. For example, the voltage 312 and/or the current 311 may be regulated using a control loop 400 in order to ensure a uniform toner transfer. In an exemplary embodiment, the control loop 400 that is used for the voltage regulation and/or current regulation may thereby be adapted virtually continuously to current values of one or more framework parameters. It may thus be ensured that a uniform print quality is achieved even given changing framework conditions (i.e. given changing values of one or more framework parameters).

In an exemplary embodiment, the method 500 may additionally include the variation of the voltage 312 and/or of the current 311 between the transfer electrode and the counter-electrode using the adapted control loop 400.

In an exemplary embodiment, the model 401 of the electrical connection path between transfer electrode and counter-electrode may be adapted depending on whether and/or how much toner is located in the roller nip. For example, the resistance 423 of a resistance model 401 may be based on whether and/or how much (quantity of) toner is located in the roller nip. In an exemplary embodiment, the quantity of toner in the roller nip may be determined using print data and/or sensor data with regard to a print image that should be printed onto the recording medium 20 at the transfer point (i.e. at the roller nip) and/or that is already located on the recording medium 20 at the transfer point. In an exemplary embodiment, the model 401 which is used for the regulation of the current 311 and/or the voltage 312 may be based on the print data and/or the sensor data. The adjustment of the electrical field 313, and the toner transfer that results from this, may thus be further improved.

In an exemplary embodiment, in a manner analogous to the method 500, a print group 11, 12 for an electrographic digital printer 10 is also described. In an exemplary embodiment, the print group 11, 12 comprises a heater 301 that is configured to heat the recording medium 20. Furthermore, the print group 11, 12 comprises a transfer electrode and a counter-electrode between which a voltage 312 may be applied in order to produce an electrical field 313 at a transfer point between the transfer electrode and the counter-electrode, such that toner is transferred onto the heated recording medium 20 at the transfer point under the effect of the electrical field 313. An improved toner transfer with reduced voltage values may thus be achieved. In an exemplary embodiment, the transfer electrode and the counter-electrode may thereby be formed by metallic surface shells (and possibly an additional outer layer, for instance an elastomer layer) of a transfer roller 121 or of a counter-pressure roller 126.

In one or more exemplary embodiments, the method 500 enables materials (and in particular paper) to be printed to that could otherwise not be used for a toner transfer under the effect of an electrical field. Furthermore, the quality of a created print image increases due to the described method 500 since the electrostatic toner transfer is enabled with a reduced voltage or with a reduced field strength. In particular, a damage to the toner due to high field strengths may be avoided. Moreover, the homogeneity of the print image may be improved since electrical non-uniformities in the recording medium 20 are reduced. The method 500 may be applied to the transfer of dry toner or liquid toner. Furthermore, the method 500 may be used given electrically assisted offset systems with pressure rollers.

In an exemplary embodiment, the method 500 uses the targeted tempering of the recording medium 20 to actively vary the electrical resistance 452 of the recording medium 20. The electrical resistance 452 is therefore reduced in a controlled manner. In an exemplary embodiment, the heating of the recording medium 20 is selected so that it does not lead to the removal of water (or limits the removal of water) from the recording medium 20, such that a reduction of the electrical resistance 452 is produced. This may be achieved via a monitoring of the current 311 and the voltage 312 during the printing process. The electrical properties of the recording medium 20 are reflected in the current/voltage behavior in the printing process and thus show the electrical effect of the tempering. In an exemplary embodiment, a separate measurement of the electrical resistance 452 of the recording medium 20 may take place. In an exemplary embodiment, the tempering of the recording medium 20 may take place such that an increase of the electrical resistance 452 does not occur due to the tempering.

In an exemplary embodiment, due to the tempering, given a current regulation, the electrical resistance 452 is reduced to such an extent that a lower transfer voltage 312 is enabled. In an exemplary embodiment, the temperature 451 may be increased such that the toner transfer takes place given a reduced (e.g., minimized) voltage 312. The inking is thereby improved and the print quality is increased. This occurs because breakdowns through the recording medium 20 are avoided and relocation processes of toner are reduced given reduced voltage 312.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, processor circuitry can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 digital printer
11, 11a-11d print group (front side)
12, 12a-12d print group (back side)
20 recording medium
20′ print image (toner)
20″ transport direction of the recording medium
21 roll (input)
22 take-off
23 conditioning group
24 turner
25 register
26 drawing group
27 take-up
28 roll (output)
30 fixer
40 climate control module
50 power supply
60 controller
70 fluid management
71 fluid controller
72 reservoir
100 electrophotography station
101 image substrate (photoconductor, photoconductor roller)
102 erasure light
103 cleaning device (photoconductor)
104 blade (photoconductor)
105 collection container (photoconductor)
106 charging device (corotron)
106′ wire
106″ shield
107 supply air channel (aeration)
108 exhaust air channel (ventilation)
109 character generator
110 developer station
111 developer roller
112 storage chamber
112′ fluid supply
113 pre-chamber
114 electrode segment
115 dosing roller (developer roller)
116 blade (dosing roller)
117 cleaning roller (developer roller)
118 blade (cleaning roller of the developer roller)
119 collection container (liquid developer)
119′ fluid discharge
120 transfer station
121 transfer roller
122 cleaning unit (wet chamber)
123 cleaning brush (wet chamber)
123′ cleaning fluid discharge
124 cleaning roller (wet chamber)
124′ cleaning fluid discharge
125 blade
126 counter-pressure roller
127 cleaning unit (counter-pressure roller)
128 collection container (counter-pressure roller)
128′ fluid discharge
129 charging unit (corotron at transfer roller)
300 controller
301 temperature sensor
302 heater
311 current (between transfer roller and counter-pressure roller)
312 voltage (between transfer roller and counter-pressure roller)
313 electrical field (at the roller nip)
314 temperature data
320, 321, 323, 326 voltage drop
330 toner layer
400 control loop
401 model
402 controller
403 controlled system
411 nominal current
413 nominal field strength
415 control error
420, 421, 422, 423, 426 model parameters (electrical resistances)
441, 442 characteristic lines
451 temperature of the recording medium
452 electrical resistance of the recording medium
453 temperature range
500 method to improve the toner transfer
501, 502, 503, 504, 505 method steps

What is claims is:

1. A method to improve the transfer of charged toner particles onto a recording medium in an electrographic printing process, the method comprising:
heating the recording medium before the transfer of the charged toner particles to reduce an electrical resistance of the recording medium;
applying a voltage between a transfer electrode and a counter-electrode to generate an electrical field at a transfer point between the transfer electrode and the counter-electrode, wherein the transfer electrode includes the charged toner particles;
guiding the recording medium to the transfer point to transition the charged toner particles from the transfer electrode to the recording medium at the transfer point under an effect of the electrical field;
detecting a current that flows between the transfer electrode and the counter-electrode across the recording medium; and
adapting the voltage based on the current.

2. The method according to claim 1, wherein the voltage is adapted such that the current is regulated based on a nominal current.

3. The method according to claim 2, further comprising:
adapting a quantity of thermal energy that is transferred to the recording medium by the heating to reduce the voltage required to regulate the current.

4. The method according to claim 1, further comprising:
determining temperature data indicative of a temperature of the recording medium after the heating; and
adapting a quantity of thermal energy that is transferred to the recording medium by the heating based on the temperature data.

5. The method according to claim 4, wherein the transferred quantity of thermal energy is adapted such that the temperature of the recording medium is regulated after the heating to a nominal temperature.

6. The method according to claim 3, further comprising:
determining temperature data indicative of a temperature of the recording medium after the heating; and
adapting the quantity of thermal energy that is transferred to the recording medium by the heating based on the temperature data.

7. The method according to claim 1, wherein:
the recording medium has an electrical resistance that is lower than or equal to a predefined resistance threshold when a temperature of the recording medium is in a predefined temperature range; and
the method further comprises heating the recording medium to a temperature outside of the predefined temperature range.

8. The method according to claim 1, wherein the heating comprises one or more of:
transferring of thermal energy to the recording medium using electromagnetic radiation;
transferring of thermal energy to the recording medium using hot air; and
transferring of thermal energy to the recording medium using contact heat.

9. The method according to claim 1, wherein the recording medium comprises one or more of:
fibers in which water is bound;
paper, cardboard and/or paperboard;
a thickness of 250 μm or a thickness of 400 μm or more; and
a grammage of 200 g/m² or more.

10. A computer program product embodied on a computer-readable medium comprising program instructions, when executed, causes a processor to perform the method of claim 1.

11. A print group of an electrographic digital printer, comprising:
a heater that is configured to heat a recording medium to reduce an electrical resistance of the recording medium; and
a transfer electrode and a counter-electrode configured to produce an electrical field at a transfer point between the transfer electrode and the counter-electrode based on an applied a voltage to the transfer electrode and the counter-electrode, wherein toner is transferred onto the heated recording medium at the transfer point under an effect of the electrical field.

12. The print group according to claim 11, wherein:
the transfer electrode comprises a transfer roller via which a toner image is conveyed at the transfer point;
the counter-electrode comprises a counter-pressure roller via which the recording medium is pressed against the transfer roller; and
the transfer roller and the counter-pressure roller form a nip as the transfer point, the toner image at the nip being transferred from the transfer roller onto the recording medium under the effect of the electrical field.

13. A method to improve the transfer of charged toner particles onto a recording medium in an electrographic printing process, the method comprising:
heating the recording medium before the transfer of the charged toner particles to reduce an electrical resistance of the recording medium;
applying a voltage between a transfer electrode and a counter-electrode to generate an electrical field at a transfer point between the transfer electrode and the counter-electrode, the transfer electrode including the charged toner particles disposed thereon;
detecting a current between the transfer electrode and the counter-electrode across the recording medium; and
adapting the voltage based on the current.

14. A print group of an electrographic digital printer that is configured to perform the method of claim 13.

15. A computer program product embodied on a computer-readable medium comprising program instructions, when executed, causes a processor to perform the method of claim 13.
